(19) United States
(12) Patent Application Publication
(10) Pub. No.: US 2008/0241509 A1
(43) Pub. Date: Oct. 2, 2008

(54) Poly lactic acid and veneer laminar structure

(76) Inventor: Chun-Chih Lai, Guishan Shiang (TW)

Correspondence Address: Troxell Law Office Pllc, Suite 1404, 5205 Leesburg Pike, Falls Church, VA, 22041, US

(21) Appl. No.: 11/980,748

(22) Filed: Oct. 31, 2007

(30) Foreign Application Priority Data
Dec. 22, 2006 (TW) 095222595

(51) Int. Cl. B32B 21/08; B32B 21/02

(52) U.S. Cl. 428/326

(57) ABSTRACT

A poly lactic acid and veneer laminar structure, in which a poly lactic acid layer is adhered to one surface or two surfaces of a wood veneer, thereby preventing the wood veneer from easily splitting apart, wherein the poly lactic acid is a polymer, the raw material of which is natural cereal crops. Moreover, a food grade wrapping paper layer is adhered to one side or two sides of the poly lactic acid layers. Accordingly, containers fabricated from the aforementioned laminar structures are biodegradable, and provide environmental protection effectiveness with regard to natural ecology.

### BACKGROUND OF THE INVENTION

(a) Field of the Invention

The present invention relates to a poly lactic acid and veneer laminar structure, and more particularly to a laminar structure which uses a poly lactic acid high polymer material adhered to one outer surface or two surfaces of a veneer, thereby improving a feature of veneers used to fabricate containers which causes them to easily split apart. Moreover, high molecular polymer layers can be adhered between the veneer and the poly lactic acid layers to improve temperature tolerance of the laminar structures, and food grade wrapping paper layers are then adhered to the most outer layers to increase food safety of the laminar structure.

(b) Description of the Prior Art

In the present market, PE (polyethylene) film is still widely used as the material for food containers. PE (polyethylene) film is one type of high molecular polymer which is unable to naturally decompose, and has continued to be a serious issue with regard to environmental protection. In the current age and under circumstances where environmental consciousness has gained ground, in addition to the gradual depletion of earth resources, the current trend is to use materials that have minimum effect on the ecology of the natural environment and to use renewable resources. Hence, areas for improvement in the continuous use of PE (polyethylene) film in large quantities await.

Furthermore, traditional wood chip containers easily create problems including developing mildew and insect damage, which not only makes it difficult to store and retain the containers, but also affects the hygienic safety of food packed in the containers. Moreover, the traditional wood chip containers have poor grease-proof and waterproof functionality, which cause cooked food to easily produce a moist and sticky condition that makes carrying inconvenient.

Therefore, it can be seen that many shortcomings remain in the aforementioned prior art, and thus the unsatisfactory designs of the prior art are in urgent need of improvement.

Hence, in light of the shortcomings derived from the aforementioned prior art, and the urgent need for improvement, after many years of painstaking efforts and meticulous study and exploration, the inventor of the present invention finally successfully developed a poly lactic acid and veneer laminar structure as disclosed herein.

### SUMMARY OF THE INVENTION

An objective of the present invention is to provide a poly lactic acid and veneer laminar structure, wherein the poly lactic acid (also named PLA) is a degradable biomolecular polymer, and products fabricated from such laminar structures are assimilated by nature when discarded, thereby substantially reducing pollution of the environment by products fabricated from wood chip structures.

In order to achieve the aforementioned objective, the poly lactic acid and veneer laminar structure of the present invention comprises a poly lactic acid layer adhered to a single side or two sides of a plurality of flat veneers, thereby improving a feature of veneers which causes them to easily split apart, wherein the wood veneer uses wood such as poplar, white birch or FALCATA (a type of leguminous plant wood). Moreover, high molecular polymer layers can be added between the wood veneer and the poly lactic acid layers to improve temperature tolerance of the laminar structure. Finally, food grade wrapping paper layers are adhered to the most outer layers to serve as an interface in contact with food.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view of a veneer and single-sided poly lactic acid laminar structure according to the present invention.

FIG. 2 shows a schematic view of the veneer and two-sided poly lactic acid laminar structure according to the present invention.

FIG. 3 shows a schematic view of the veneer, single-sided poly lactic acid and single-sided food grade wrapping paper laminar structure according to the present invention.

FIG. 4 shows a schematic view of the veneer, two-sided poly lactic acid and two-sided food grade wrapping paper laminar structure according to the present invention.

FIG. 5 shows a schematic view of the veneer, single-sided high molecular polymer, single-sided poly lactic acid and single-sided food grade wrapping paper laminar structure according to the present invention.

FIG. 6 shows a schematic view of the veneer, two-sided high molecular polymer, two-sided poly lactic acid and two-sided food grade wrapping paper laminar structure according to the present invention.

FIG. 7 shows a view of an embodiment (1) depicting a container fabricated from the poly lactic acid and veneer laminar structure.

FIG. 8 shows a view of an embodiment (2) depicting a container fabricated from the poly lactic acid and veneer laminar structure.

FIG. 9 shows a view of an embodiment (3) depicting a container fabricated from the poly lactic acid and veneer laminar structure.

### DETAILED DESCRIPTION OF THE PREFERRED EMBODIMENTS

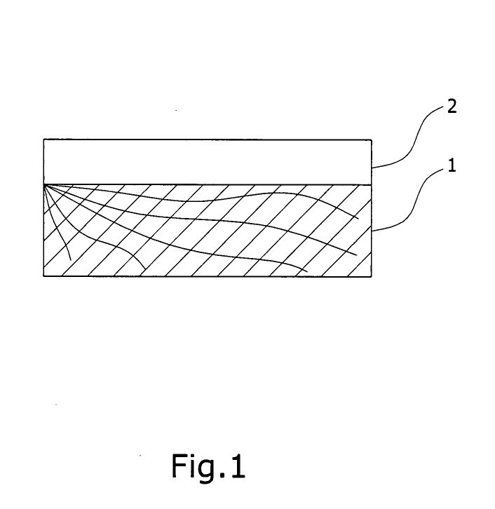

Referring to FIG. 1, which shows a poly lactic acid and veneer laminar structure of the present invention, primarily comprising a wood veneer 1, one surface of which is adhered to a layer of poly lactic acid layer 2 using mechanical heating and compression means that prevents the wood veneer 1 from easily splitting apart, wherein the poly lactic acid layer 2 is a degradable biomolecular polymer which provides increased grease-proof and waterproof functionality. The wood veneer 1 is structured from laminated wood chip, using wood such as poplar, white birch or falcata (a type of leguminous plant wood), having a thickness of 0.1 cm to 0.3 cm, while the poly lactic acid layer 2 is a polymer, the raw material of which is natural cereal crops, and is a biodegradable biomolecular polymer, also named PLA (Poly Lactic Acid).

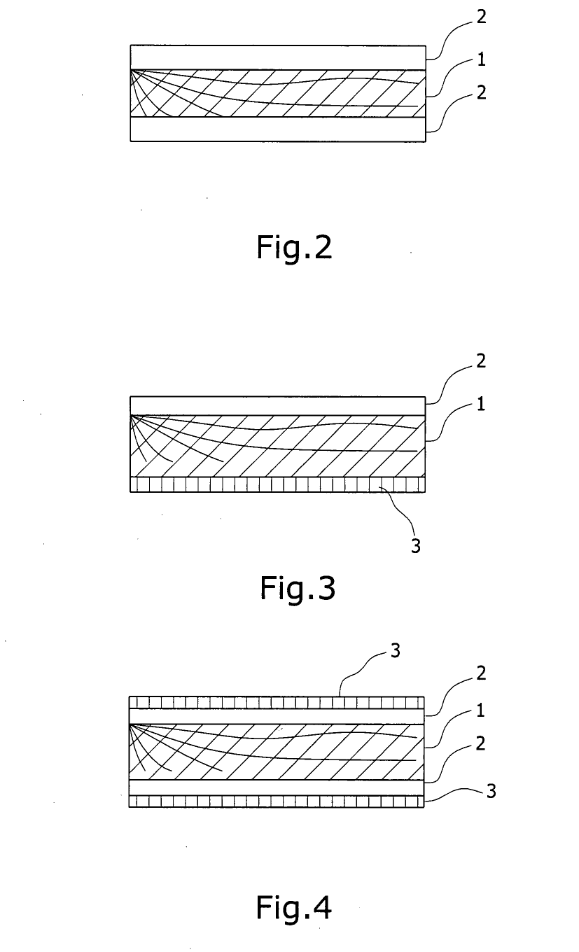

FIG. 2 shows the poly lactic acid layer 2 adhered to the two surfaces of the wood veneer 1 using mechanical heating and compression means.

FIG. 3 shows the poly lactic acid layer 2 adhered to one outer surface of the wood veneer 1 using mechanical heating and compression means, while a food grade wrapping paper layer 3 is adhered to the other outer surface of the wood veneer 1 again using mechanical heating and compression means, which increases hygienic safety of a container fabricated from the laminar structure when filled with food.

FIG. 4 shows the poly lactic acid layer 2 adhered to the two surfaces of the wood veneer 1, while the food grade wrapping paper layer 3 is adhered to the two outer surfaces of the poly lactic acid layers 2 again using mechanical heating and compression means.

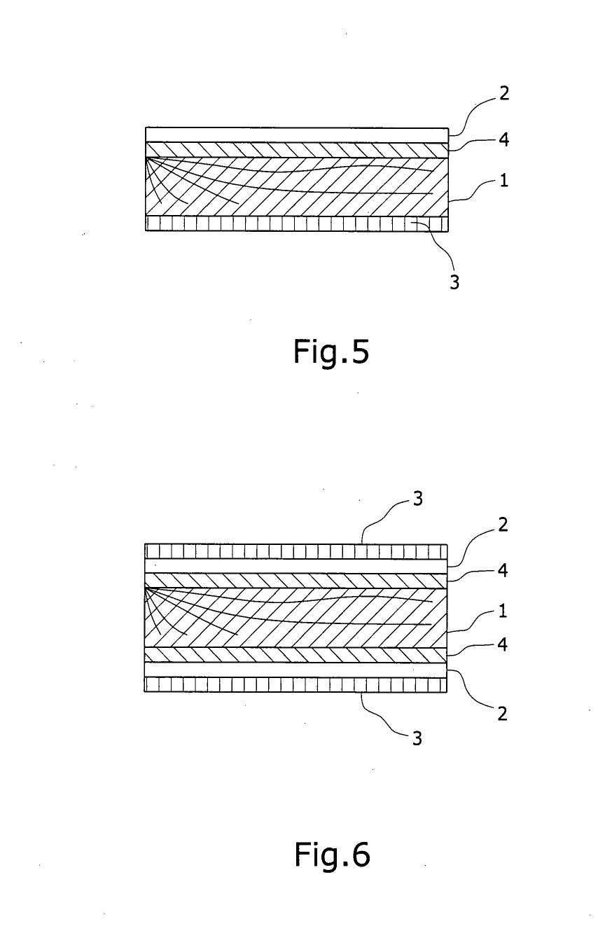

The laminar structure of FIG. 5 depicts an embodiment wherein a high molecular polymer layer 4 is first adhered to one surface of the wood veneer 1 using heating and compression means, and then the poly lactic acid level 2 and the food grade wrapping paper layer 3 are sequentially adhered to the high molecular polymer layer 4 and the other surface of the wood veneer 1 respectively using heating and compression means. The high molecular polymer layer 4 is used to improve temperature tolerance of the laminar structure.

The laminar structure of FIG. 6 depicts an embodiment wherein the high molecular polymer layer 4 is first adhered to the two surfaces of the wood veneer 1 using heating and compression means, then the poly lactic acid level 2 and the food grade wrapping paper layer 3 are sequentially adhered to the outer surfaces using heating and compression means.

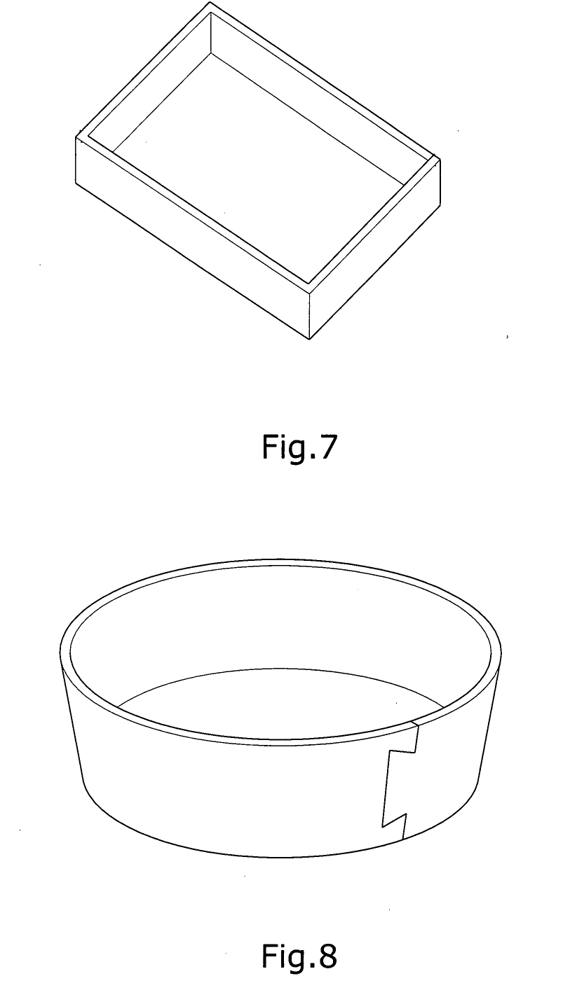

FIG. 7 shows a square container fabricated from the aforementioned poly lactic acid and wood veneer laminar structure. The container can also be fabricated as a hexagonal, octagonal or polygonal shaped container.

FIG. 8 shows a circular container fabricated from the aforementioned poly lactic acid and wood veneer laminar structure. The container can also be fabricated as an elliptical shaped container.

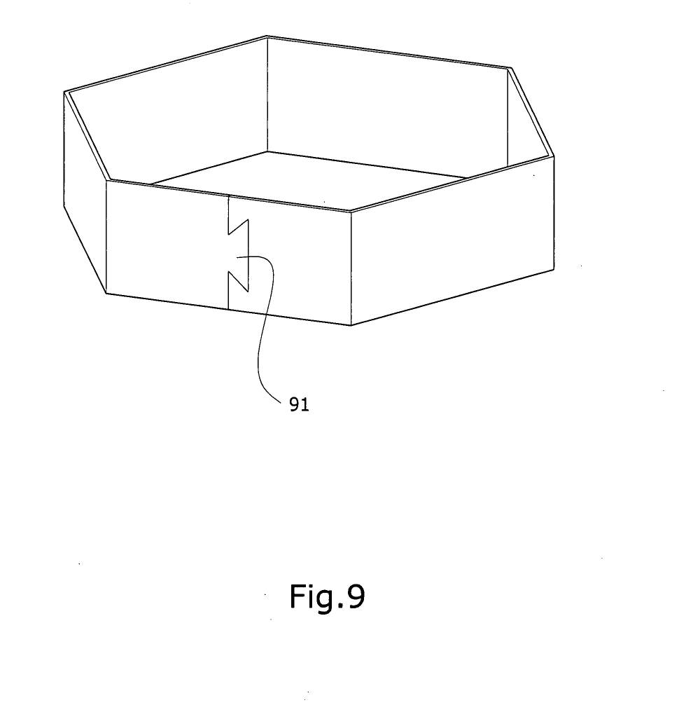

FIG. 9 shows a container fabricated from the aforementioned poly lactic acid and wood veneer laminar structure, wherein the joining portion is structured to comprise two corresponding hook fastening structures 91.

The poly lactic acid and veneer laminar structure provided by the present invention has the following advantages compared to other prior art:

1. Material used in the present invention is naturally recyclable, unlike plastic material which cannot be decomposed by microorganisms in nature, and thus imposes a significantly smaller burden on the environment.

2. The poly lactic acid used in the present invention is a polymer extracted and manufactured from crops, and the products fabricated therefrom can be returned to nature by compost means after use, thus, the raw material source can be said to be inexhaustible. However, the plasticized material of prior art comes from petroleum, and considering the speed at which the human race is using energy resources, the day when energy resources are depleted is fast approaching. Hence, application of poly lactic acid material can reduce the use of energy resources and maintain sustainable development of the earth.

3. Residual wood shavings of common traditional wood chip easily become moldy, cause fungus to grow or allow penetration of oil and water, whereas the laminar structures adhered with poly lactic acid layers of the present invention are able to achieve grease-proof and waterproof functionality and increase sanitary conditions.

In conclusion, effectiveness of the poly lactic acid and veneer laminar structure provides the present invention with practicability and advancement. Accordingly, the applicant proposes an application for a new patent herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A poly lactic acid and veneer laminar structure, comprising:
a wood veneer, the wood veneer being structured from laminated wood chip having a thickness of 0.1 cm to 0.3 cm; and
a poly lactic acid layer, the poly lactic acid layer being a polymer, the raw material of which is natural cereal crops, and is adhered to a surface of the wood veneer using heating and compression means.

2. The poly lactic acid and veneer laminar structure according to claim 1, wherein the poly lactic acid layer is adhered to one surface or two surfaces of the wood veneer.

3. A poly lactic acid and veneer laminar structure, comprising:
a wood veneer, the wood veneer being structured from laminated wood chip having a thickness of 0.1 cm to 0.3 cm;
a poly lactic acid layer, the poly lactic acid layer being a polymer, the raw material of which is natural cereal crops, and is adhered to a surface of the wood veneer using heating and compression means; and
a food grade wrapping paper layer, the food grade wrapping paper layer being adhered to a surface of the poly lactic acid layer using heating and compression means.

4. The poly lactic acid and veneer laminar structure according to claim 3, wherein the poly lactic acid layer and the food grade wrapping paper layer are sequentially adhered to one surface or two surfaces of the wood veneer.

5. A poly lactic acid and veneer laminar structure, comprising:
a wood veneer, the wood veneer being structured from laminated wood chip having a thickness of 0.1 cm to 0.3 cm;
a high molecular polymer layer, the high molecular polymer layer being adhered to a surface of the wood veneer;
a poly lactic acid layer, the poly lactic acid layer being a polymer, the raw material of which is natural cereal crops, and is adhered to a surface of the high molecular polymer layer using heating and compression means; and
a food grade wrapping paper layer, the food grade wrapping paper layer being adhered to a surface of the poly lactic acid layer using heating and compression means.

6. The poly lactic acid and veneer laminar structure according to claim 5, wherein the high molecular polymer layer, the poly lactic acid layer and the food grade wrapping paper layer are sequentially adhered to one surface or two surfaces of the wood veneer.
